(19) United States
(12) Patent Application Publication
(10) Pub. No.: US 2006/0010866 A1
(43) Pub. Date: Jan. 19, 2006

(54) Pressurized near-isothermal fuel cell - gas turbine hybrid system

(75) Inventors: Timothy Joseph Rehg, Rancho Palos Verdes, CA (US); Pavel Alexandrovich Sokolov, Redondo Beach, CA (US); Wolfgang Alan Fengler, Torrance, CA (US)

Correspondence Address: NIXON & VANDERHYE P.C., 901 NORTH GLEBE ROAD, 11TH FLOOR, ARLINGTON, VA, 22203, US

(73) Assignee: General Electric Company, Schenectady, NY (US)

(21) Appl. No.: 10/879,057

(22) Filed: Jun. 30, 2004

(51) Int. Cl. H01M 8/00; H01M 8/04; F03G 6/00; H01M 8/12; B60L 8/00; B60K 16/00

(52) U.S. Cl. 60/641.8; 429/12; 429/13; 429/26

(57) ABSTRACT

A hybrid fuel cell-gas turbine system and method efficiently generates power using a combination of separate power generating components. The system includes a turbine system having an air compressor and a turbine, and a fuel cell. By-product waste heat from the fuel cell is used within the fuel cell to heat the cathode air.

### BACKGROUND OF THE INVENTION

The present invention relates to a hybrid system combining a gas turbine (GT) or a micro-turbine (MT) with a near-isothermal high-temperature fuel cell, for example a solid oxide fuel cell (SOFC), to produce electrical power.

Though very efficient power producers, fuel cells still generate much by-product heat that needs to be removed to avoid overheating the fuel cell. High-temperature fuel cells, such as the solid oxide fuel cell (SOFC), systems are normally designed so that the by-product heat is removed with airflow through the fuel cell. The air also serves as the reactant in the fuel cell cathode. Usually, the cooling requirement imposed on the airflow results in a much higher airflow rate than that required for the fuel cell reaction due to the poor heat transfer characteristics of air and, equally importantly, the inability of the SOFC stack to withstand a large thermal gradient or temperature rise from stack inlet to stack exhaust due to thermal stresses. The presence of large temperature gradients may be detrimental to both structural integrity and reliability of the stack. If the temperature rise is too large, differential thermal expansion of various stack components (cell, interconnect, seals, etc.) can lead to cell fracture, loss of sealing, or loss of contact between stack components, thereby leading to stack failure. In the absence of stack failure, stack service life is compromised due to the fact that cell component degradation is strongly temperature dependent. Cell degradation is much faster in the high temperature region (typically near the exhaust) than in the low temperature region (typically near the inlet), thereby over time leading to reduced stack power or system efficiency, or both. Thus, only part of the airflow through the fuel cell is used for reaction purposes with the rest of the airflow serving the stack cooling purpose. The power required for circulating this additional cooling airflow lowers the overall system efficiency.

Additionally, because the SOFC stack cannot withstand large temperature gradients, it is necessary to preheat the air to a temperature nearly equal to the stack temperature before it enters the stack. This heat transfer process is also inefficient, resulting in some loss of system efficiency, and is also complicated and expensive due to the need to employ high temperature materials consistent with the high operating temperatures of SOFC stacks. These problems can be solved if a more efficient fuel cell cooling method is devised.

In state-of-the-art systems, the task of preheating air to the fuel cell operating temperature is accomplished utilizing either the heat of compression in high-pressure systems (see, e.g., U.S. Pat. No. 5,482,791) or the gas turbine by-product heat transferred to the cathode air via a high-temperature heat exchanger (see, e.g., U.S. Pat. No. 5,413,879). The former method suffers from reduced system efficiency at low pressure, while the latter employs an unreliable component, the high-temperature heat exchanger, which is subject to high thermal stresses and high material oxidation rates due to its exposure to high temperature.

### BRIEF DESCRIPTION OF THE INVENTION

In an exemplary embodiment of the invention, a system for generating power includes a turbine system including an air compressor and a turbine having an inlet and an outlet; and a fuel cell including a plurality of power-producing electrode-electrolyte assemblies and heat-conducting elements. The air compressor supplies cathode air to the fuel cell, and the cathode air is predominately heated inside the fuel cell by fuel cell by-product heat via the heat-conducting elements.

In another exemplary embodiment of the invention, a method of generating power utilizing the system of the invention includes the steps of supplying cathode air to the fuel cell via the air compressor; and heating the cathode air inside the fuel cell by fuel cell by-product heat via the heat-conducting elements.

### BRIEF DESCRIPTION OF THE DRAWINGS

FIG. 1 is a schematic process diagram of a hybrid fuel cell-gas turbine system;

FIG. 2 is a flow diagram illustrating a flow process of the system;

FIG. 3 is a graphic showing the impact of air temperature rise in the stack on system efficiency;

FIGS. 4 and 5 show fuel cell interconnects containing heat-conducting elements; and

FIGS. 6 and 7 show top views of fuel cell interconnects.

### DETAILED DESCRIPTION OF THE INVENTION

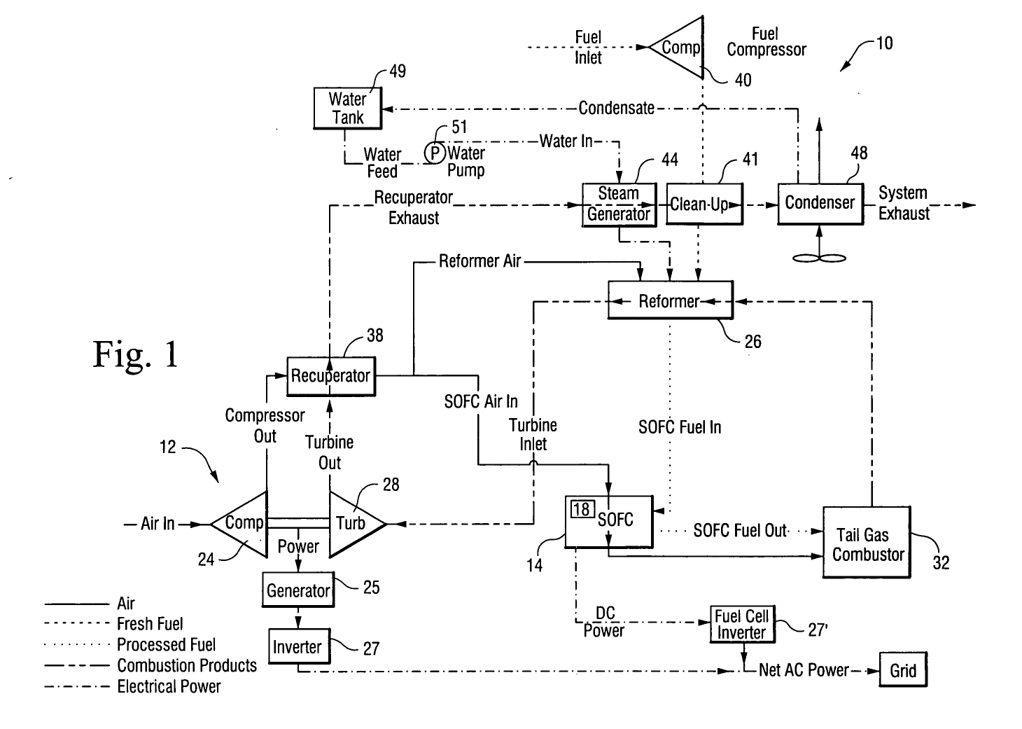

The system 10 will be described with reference to FIG. 1. Generally, the hybrid system 10 includes a turbine component 12 and a fuel cell component. The fuel cell component includes a fuel cell 14 having a plurality of power-producing electrode-electrolyte assemblies, flow distribution assemblies, and heat-conducting elements 18, such as heat pipes, which may or may not be connected to the flow distribution assemblies. As an alternative to heat pipes, high thermal conductance members may be used. The heat-conducting elements 18 have a high thermal conductance, which allows for an efficient transfer of fuel cell by-product heat to incoming reactants. The high thermal conductivity of the elements 18 allows for very small temperature gradients in the fuel cell, thus making the fuel cell nearly isothermal. In addition, the heat-conducting elements are typically good electrical current conductors and may serve as the fuel cell's interconnects that serve the purpose of transferring current from one cell to the next.

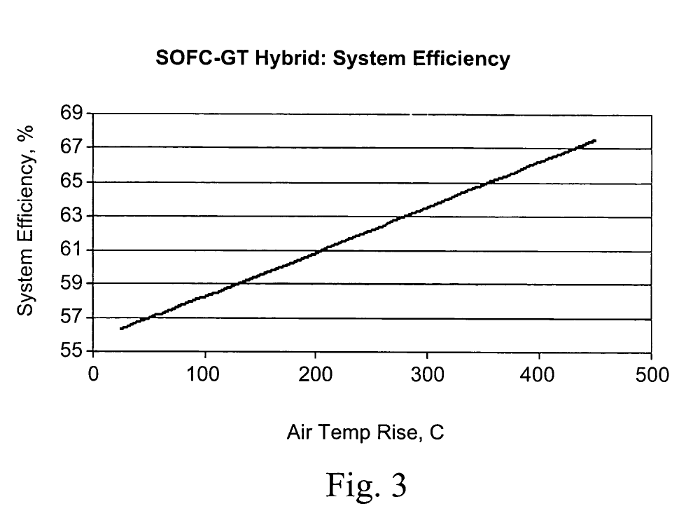

The fuel cell 14 has fuel (anode) and air (cathode) chambers that provide the reactants required for the fuel cell reaction. While the fuel cell is nearly isothermal due to the heat conduction elements 18, the waste heat must still be removed from the stack to prevent the stack from overheating and attaining a temperature higher than desired. The byproduct heat of the fuel cell 14 necessitates the use of excess cathode air for temperature control and cooling purposes, but not for the purpose of minimizing temperature gradients, as the heat conducting elements accomplish this purpose. In order to maintain the fuel cell operating temperature, the air used in the fuel cell 14 cathode absorbs byproduct heat and is heated to a temperature just below the fuel cell operating temperature. Because the cathode air is used for reaction purpose and heat removal purpose, but not thermal gradient control purposes as in conventional systems, lower air flows and temperatures are possible, thereby increasing system efficiency, as shown in FIG. 3. Because the cell is held nearly isothermal by the heat conducting elements 18, cooler air can be introduced into the fuel cell without damaging the cells for heat removal purposes than can be used in conventional systems. The fuel cell by-product heat is then conducted via the heat-conducting elements and other stack components to directly heat the fuel cell cathode air. The solution herein heats the air directly utilizing the fuel cell by-product heat and thus eliminates the need for a high-temperature heat exchanger while operating the system at a reasonably low pressure to achieve high system efficiency.

In a preferred embodiment, a GT compressor 24 of the turbine component 12 supplies the fuel cell with air. An external fuel processor or reformer 26 partially or fully converts fuel to a hydrogen-containing gas (fuel conversion in the external fuel processor can range from 0% to 100%) before feeding it to the fuel cell 14. The preferred embodiment of the fuel processor 26 is a steam reformer. The remaining fuel may be processed in the fuel cell 14 to produce more hydrogen-containing gas. The fuel cell 14 produces electrical power from the GT air and the converted fuel. All or part of the fuel cell by-product heat is conducted to the inlet airflow thus heating it to nearly the fuel cell operating temperature and removing byproduct heat from the system.

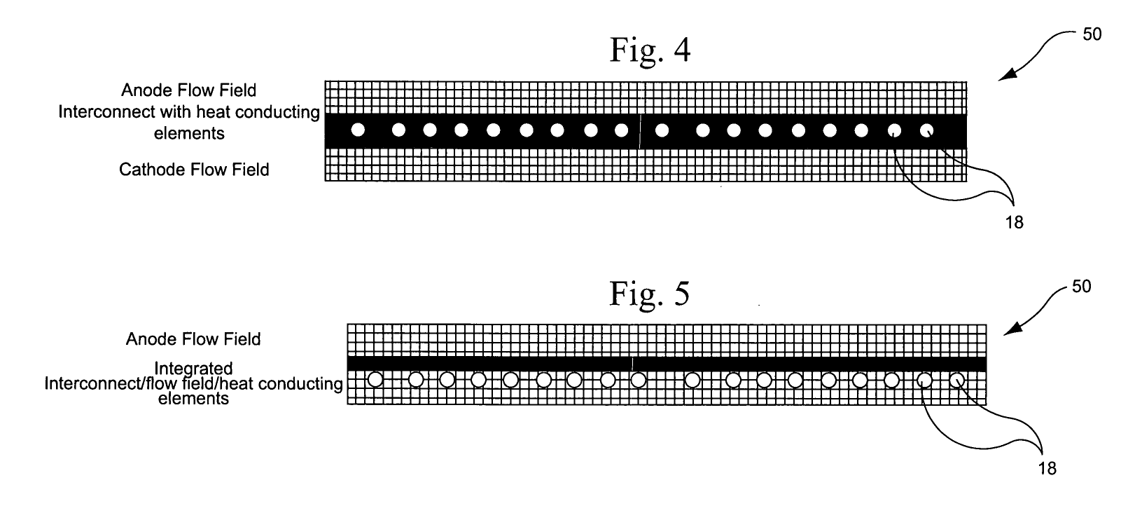

A schematic of a fuel cell interconnects containing heat-conducting elements is shown in FIGS. 4-7. In FIG. 4, a cross sectional view of a fuel cell interconnect 50, often called a bipolar plate, is shown. The anode flow field is shown at the top surface of the interconnect 50 and serves the purpose of directing anode gas to the adjacent cell. The cathode flow field is shown at the bottom surface of the interconnect 50 and serves the purpose of directing cathode gas to the adjacent cell. In the core of the plate 50 are the heat-conducting elements 18. Alternatively, the heat conducting elements 18 can be located in the cathode flow field as shown in FIG. 5 (or less preferentially in the anode flow field). The top surface of the interconnect interfaces to the anode side of a cell. The cell and interconnect 50 comprise a repeat unit within the stack. The bottom face of the interconnect 50 interfaces to the cathode side of an adjacent cell.

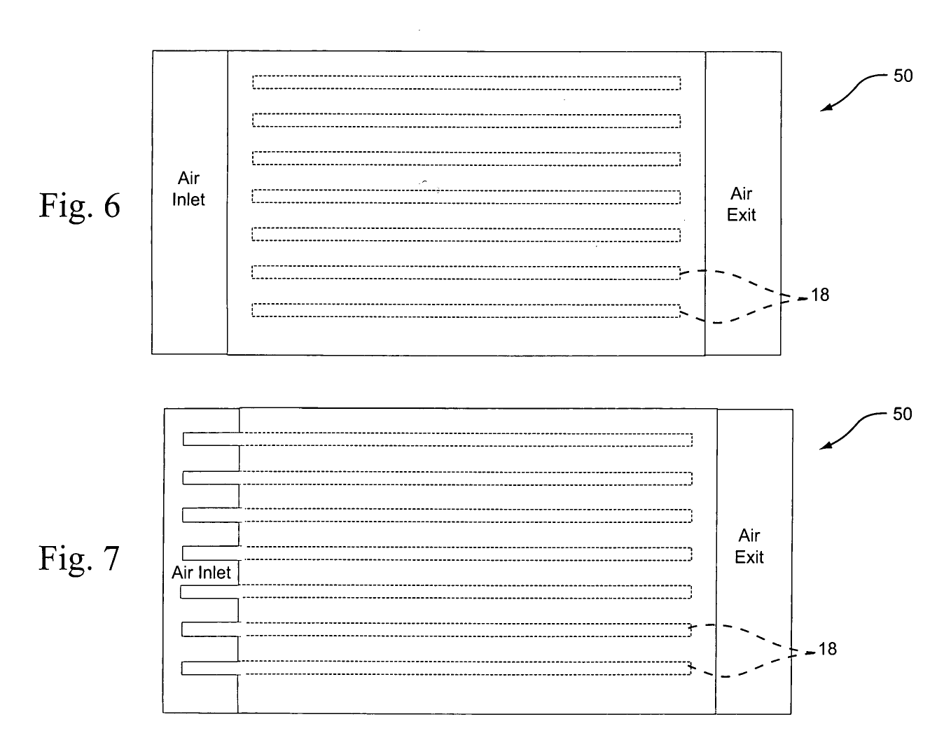

Shown in FIGS. 6 and 7 are top views of a fuel cell interconnect 50 containing heat-conducting elements 18. The interconnect 50 is shown in two configurations, whereby the heat-conducting elements either begin and end within the active area of the fuel cell (FIG. 6), or alternatively, begin in the active area of the fuel cell and end in the air inlet manifold (FIG. 7). Heat generated within the anode and cathode of the cell during electrochemical operation is conducted through the interconnect to the heat conducting elements, and is transferred in the plane of the interconnect, thereby minimizing temperature gradients within the cell and interconnect while simultaneously transferring heat to the cathode gas (the air).

In the case where the heat conducting elements 18 are heat pipes, their condenser sections are located adjacent the air inlet manifold to enable heat transfer from the heat pipes to the relatively cold inlet air, while the evaporator sections absorb the fuel cell byproduct heat and conduct it to the condenser sections. While the condenser section is located in proximity to the air inlet manifold, it may or may not extend all the way into the manifold as shown in FIGS. 6-7. In the case where the heat conducting elements are high conductance members, the cross sectional area and thermal conductivity of the members are chosen and arranged within the stack so as to transfer heat from the hot regions of the fuel cell to the cold regions of the fuel cell by thermal conduction.

As would be apparent to those of ordinary skill in the art, the heat conducting elements are not necessary in each interconnect. Rather, for example, the heat conducting elements may be placed in alternate ones of the interconnects (every 3rd or 5th), or another combination.

The turbine component 12 also includes a GT turbine 28 which together with the compressor 24 generates AC power via a known generator 25 and inverter 27. Any remaining waste fuel cell heat may be transported to other parts of the system to improve system efficiency.

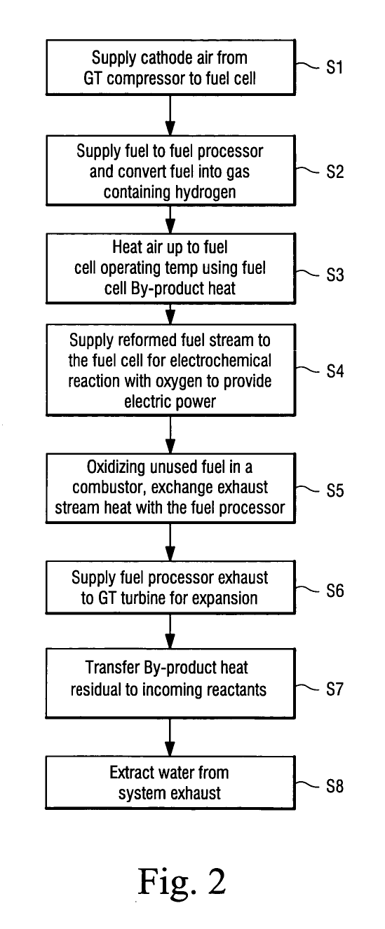

The system supplies air and fuel to the fuel cell 14 at pre-determined flow rates and appropriate pressure and temperature. With continued reference to FIG. 1 and with reference to FIG. 2, the GT compressor 24 supplies cathode air to the fuel cell 14 (step S1). Fuel (such as natural gas) is supplied by a fuel compressor 40 via a fuel clean up system 41, which removes constituents from the fuel that may harm the fuel reformer or fuel cell (for example, sulfur containing compounds), to the fuel processor 26 (a.k.a. the reformer) that uses steam reforming, auto-thermal reforming, partial-oxidation, or other known processes to convert the fuel into a gas containing hydrogen (step S2). The cell is held nearly isothermal by the heat conducting elements. The air is heated up to the fuel cell operating temperature inside the fuel cell 14 using the fuel cell by-product heat transferred to the inlet air by the heat-conducting elements 18 and other components of the fuel cell (step S3). The air temperature rise from fuel cell 14 inlet to exhaust is preferably greater than 25° C., more preferably between about 25-500° C., and most preferably about 100-400° C.

The reformed fuel stream is supplied to the fuel cell 14, where it is electrochemically reacted with oxygen in the supplied air to produce electrical power (step S4) via an inverter 27′. Any unused fuel is oxidized in a tail gas combustor 32 downstream of the fuel cell 14, and the exhaust stream exchanges heat with the fuel processor 26 (step S5). The tail gas combustor 32 exhaust, after being directed to the fuel processor and exchanging heat with the fuel processor, is exhausted from the fuel processor 26 and expands in the GT turbine 28 to produce more power (step S6).

Any residual by-product heat produced during the fuel cell electrochemical reaction is transferred to the incoming reactants, such as air, inside a low temperature recuperator 38 or is used to produce steam in the steam generator 44 for the fuel processor 26 (step S7). Water is extracted in the condenser 48 and stored in a water tank 49 for the system exhaust and is delivered to the steam generator 44 via a water pump 51 (step S8).

An advantage of transferring the by-product heat directly to the incoming air within the stack is the elimination of the need to pre-heat the air with other means, such as high-temperature heat exchangers, that historically have been shown to be unreliable. Analyses have shown that the steady-state system efficiency of this concept may be between about 60 and 68%.

The system utilizes exhaust heat from separate power generating components, resulting in a high-temperature fuel cell-GT hybrid system design with a near-isothermal fuel cell design allowing increased overall system efficiency.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

Other such embodiments might include introducing fuel into the fuel cell that is colder than that introduced into conventional systems as an alternative to, or in combination with, the introduction of air colder than that allowed by conventional systems. The inventions described are applicable to SOFC, MCFC, and phosphoric acid fuel cells.

What is claimed is:

1. A system for generating power comprising:
a turbine system including an air compressor and a turbine having an inlet and an outlet; and
a fuel cell including a plurality of power-producing electrode-electrolyte assemblies and heat-conducting elements,
wherein the air compressor supplies cathode air to the fuel cell, and wherein the cathode air is heated inside the fuel cell by fuel cell by-product heat via the heat-conducting elements.

2. A system according to claim 1, further comprising a fuel processor receiving fuel from a fuel source and processing the fuel for input to the fuel cell.

3. A system according to claim 2, wherein the fuel processor comprises means for converting the fuel into a gas containing hydrogen.

4. A system according to claim 2, wherein the fuel cell further comprises a fuel input section receiving the processed fuel from the fuel processor, and a fuel cell combustor that oxidizes any unused fuel for heat exchange in the fuel processor.

5. A system according to claim 2, the system further comprising a steam generator supplying fuel processor steam to the fuel processor via turbine exhaust from the turbine outlet.

6. A system according to claim 1, wherein an air temperature rise from the fuel cell inlet to exhaust is greater than 25° C.

7. A system according to claim 1, wherein an air temperature rise from the fuel cell inlet to exhaust is between about 25 and 500²C.

8. A system according to claim 1, wherein an air temperature rise from the fuel cell inlet to exhaust is between about 100 and 400° C.

9. A method of generating power utilizing a hybrid fuel cell-gas turbine system, the turbine system including an air compressor and a turbine having an inlet and an outlet, and the fuel cell including a plurality of power-producing electrode-electrolyte assemblies and heat-conducting elements, the method comprising:
supplying cathode air to the fuel cell via the air compressor; and
heating the cathode air inside the fuel cell by fuel cell by-product heat via the heat-conducting elements.

10. A method according to claim 9, further comprising receiving fuel from a fuel source and processing the fuel for input to the fuel cell.

11. A method according to claim 10, wherein the processing step comprises converting the fuel into a gas containing hydrogen.

12. A method according to claim 10, further comprising receiving in a fuel input section the processed fuel from the fuel processor, and oxidizing any unused fuel in a fuel cell combustor for heat exchange in the fuel processor.

13. A method according to claim 10, further comprising supplying fuel processor air to the fuel processor via the air compressor and supplying fuel processor steam to the fuel processor via a steam generator exchanging heat with the turbine exhaust from the turbine outlet.

14. A method according to claim 9, wherein an air temperature rise from the fuel cell inlet to exhaust is greater than 25° C.

15. A method according to claim 9, wherein an air temperature rise from the fuel cell inlet to exhaust is between about 25 and 450° C.

16. A method according to claim 9, wherein an air temperature rise from the fuel cell inlet to exhaust is between about 100 and 400° C.
